(19) United States
(12) Patent Application Publication
(10) Pub. No.: US 2007/0064281 A1
(43) Pub. Date: Mar. 22, 2007

(54) Scanner

(75) Inventor: Liu Zhi Yang, Suzhou (CN)

Correspondence Address: QUINTERO LAW OFFICE, PC, 2210 MAIN STREET, SUITE 200, SANTA MONICA, CA, 90405, US

(73) Assignee: BENQ CORPORATION, TAOYUAN (TW)

(21) Appl. No.: 11/523,903

(22) Filed: Sep. 19, 2006

(30) Foreign Application Priority Data
Sep. 20, 2005 (TW) TW94132484

(51) Int. Cl. H04N 1/04

(52) U.S. Cl. 358/474

(57) ABSTRACT

A scanner includes a main body, a cover, a back plate and a positioning mechanism. The cover is pivoted to the main body. The back plate is disposed between the main body and the cover with one end pivoted to the main body and another end connected to the cover. The positioning mechanism is disposed on the cover and connecting the back plate and the cover, whereby the back plate is maintained at a predetermined position on the cover at an angle with respect to the main body.

### BACKGROUND

The invention relates to a scanner, and in particular to a standing scanner or hanging scanner capable of preventing the scanned object from being inclined or falling off.

Typically, when used, a scanner often lies flat on a desk. As the available space on a desk may be limited, and the scanner lying flat thereon occupies a considerable amount of space, a standing scanner is desirable.

Although a standing scanner occupies less space, the scanned documents are difficult to position. R.O.C patent No. 529869 discloses a scanner overcoming the positioning problem. Referring to FIGS. 1A, 1B and 1C, a conventional standing scanner 10 comprises a housing 1, a transparent glass plate 2, a cover 3 and a base 4. The cover 3 is pivoted to the housing 1 via a pivot mechanism 7. The housing 1 is erected by the base 4. A flange 11 is formed on the housing 1 adjacent to the transparent glass plate 2. A scanned document 5 is positioned by abutting the flange 11. In FIG. 1B, the flange 11 has a protrusion 12 on ends thereof to constrain the scanned document 5. In addition, a pressing member 6 is disposed on the inner side of the cover 3. The pressing member 6 has a convex surface facing the transparent glass plate, whereby the document 5 is pressed against the transparent glass plate 2.

In such a structure, the flange 11, the protrusion 12 and the pressing member 6 increases the size and weight of the scanner 10, and the convex surface thereof creates a gap between the housing 1 and the cover 3. The gap and the flange 11 prevent the cover 3 from tightly abutting the housing 1. Soft or folded documents cannot be stably positioned on the flange 11. Additionally, when the cover 3 is opened, the pivot mechanism sustains all force exerted on the cover 3. This shortens the service life of the pivot mechanism.

To solve the described problem, the applicant submits another application, R.O.C application No. 94118163, disclosing a document positioning structure. Referring to FIG. 1D, a scanner comprises a main body 1′, a cover 3′, a back plate 35′, a supporter 4′ and a soft pad 6′. The back plate 35′ is pivoted to the main body 1′ via a pivot mechanism 7′. In the application, the connection between the back plate 35′ and the main body 1′ was disclosed. So in this invention, the connection between the back plate and the cover is disclosed.

### SUMMARY

An embodiment of a scanner of the invention comprises a main body, a cover, a back plate and a positioning mechanism. The cover is pivoted to the main body. The back plate is disposed between the main body and the cover with one end pivoted to the main body and another end connected to the cover. The positioning mechanism is disposed on the cover and connected to the back plate and the cover, whereby the back plate is maintained at a predetermined position on the cover at an angle with respect to the main body.

The back plate comprises a protrusion, and the positioning mechanism comprises a groove where the protrusion slides in a first direction.

The positioning mechanism further comprises an elastic element connecting the protrusion and the groove.

The positioning mechanism further comprises a first track and a sliding block disposed on the first track capable of sliding in a second direction. The sliding block comprises a stop block constraining the protrusion, whereby the cover is opened to an angle with respect to the main body. The first direction can be perpendicular to the second direction.

The back plate comprises a protrusion. The positioning mechanism comprises a groove and a sliding block slidably disposed in the groove. The protrusion and the sliding block move in the same direction.

The sliding block comprises a stop block abutting the protrusion. The position of the stop block determines the moving distance of the protrusion to determine the angle between the cover and the main body.

The positioning mechanism further comprises a second track parallel to the groove. The sliding block is disposed on the second track and capable of sliding thereon.

The second track comprises a plurality of teeth, and the sliding block comprises a hook movably holding one of the teeth.

The sliding block comprises a holding portion slidably held on the second track.

The holding portion comprises a recess corresponding to the second track.

The cover comprises a channel. The back plate comprises an engaging portion detachably engaging the channel. When the engaging portion engages the channel, the back plate is positioned on the cover.

The engaging portion comprises an engaging tip engaging the channel which is U-shaped.

The back plate comprises a protrusion, and the positioning mechanism comprises an elastic element connecting the protrusion and the back plate.

Compared with the application, R.O.C application No. 94118163, the invention discloses the connection between the back plate and the cover which can be positioned at a predetermined angle to ensure the document positioning and protect the pivot mechanism.

### BRIEF DESCRIPTION OF THE DRAWINGS

The invention can be more fully understood by reading the subsequent detailed description and examples with references made to the accompanying drawings, wherein:

FIG. 1A is a schematic view of a conventional standing scanner;

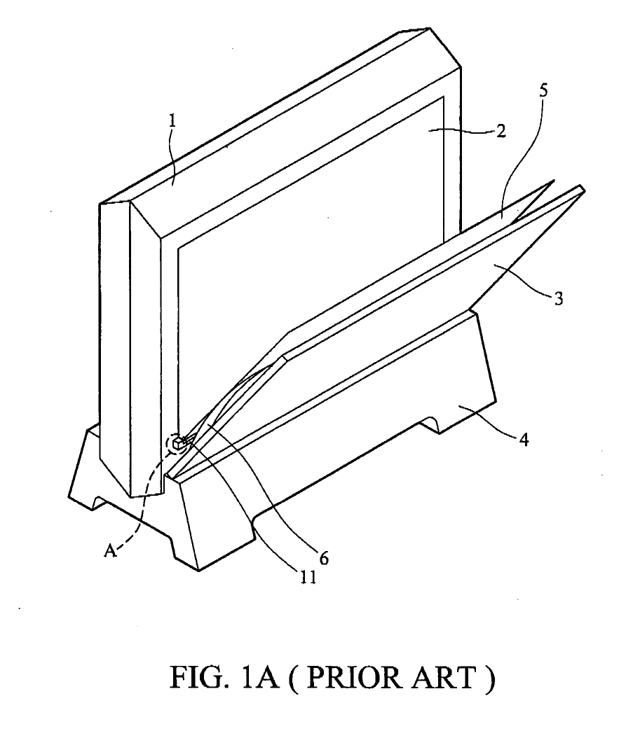

FIG. 1B is an enlarged view of portion A of FIG. 1A;

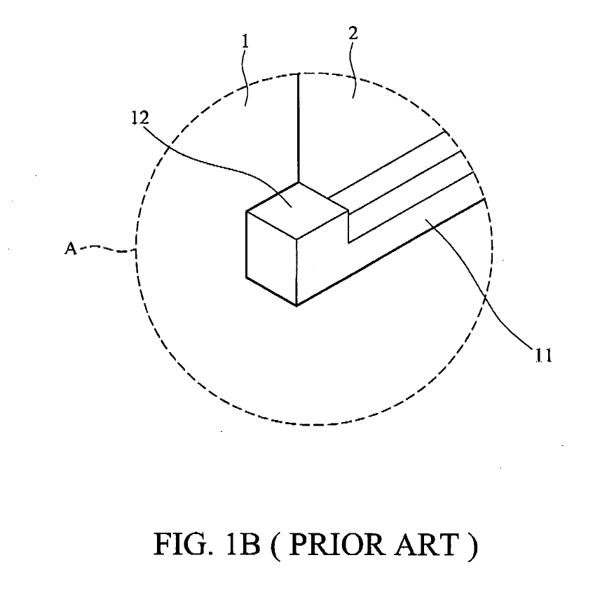

FIG. 1C is a cross section of a conventional standing scanner;

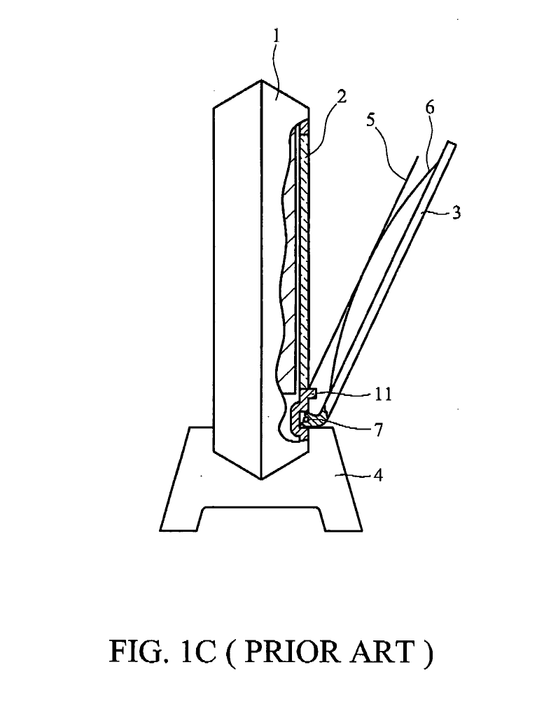

FIG. 1D is a schematic view of another conventional standing scanner;

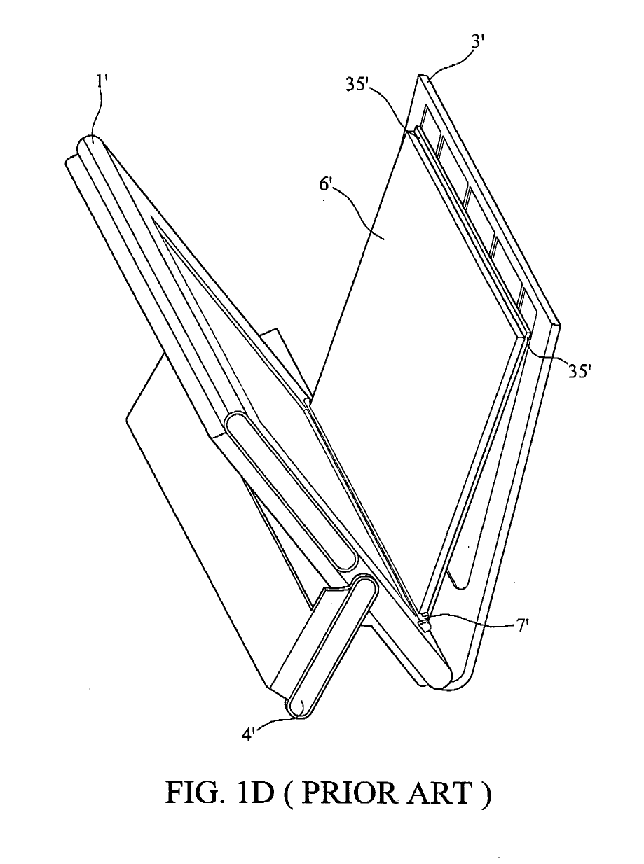

FIG. 2A is a perspective view of an embodiment of a scanner of the invention;

FIG. 2B is an enlarged view of the positioning mechanism of FIG. 2A;

FIG. 2C is an exploded view of the positioning mechanism;

FIG. 2D depicts the positioning mechanism when the cover is completely opened;

FIG. 2E is a side view of the scanner of the invention when the cover is completely opened;

FIG. 3A is a perspective view of another embodiment of a scanner of the invention;

FIG. 3B is an enlarged view of the positioning mechanism of FIG. 3A;

FIG. 3C depicts the sliding block of the positioning mechanism;

FIG. 4A is a schematic view of another embodiment of the scanner of the invention;

FIG. 4B is an enlarged view showing the back plate not positioned on the cover;

FIG. 4C is an enlarged view showing the back plate positioned on the cover;

FIG. 5A is a schematic view of another embodiment of the scanner of the invention; and

FIG. 5B is a schematic view of another embodiment of the scanner of the invention.

### DETAILED DESCRIPTION

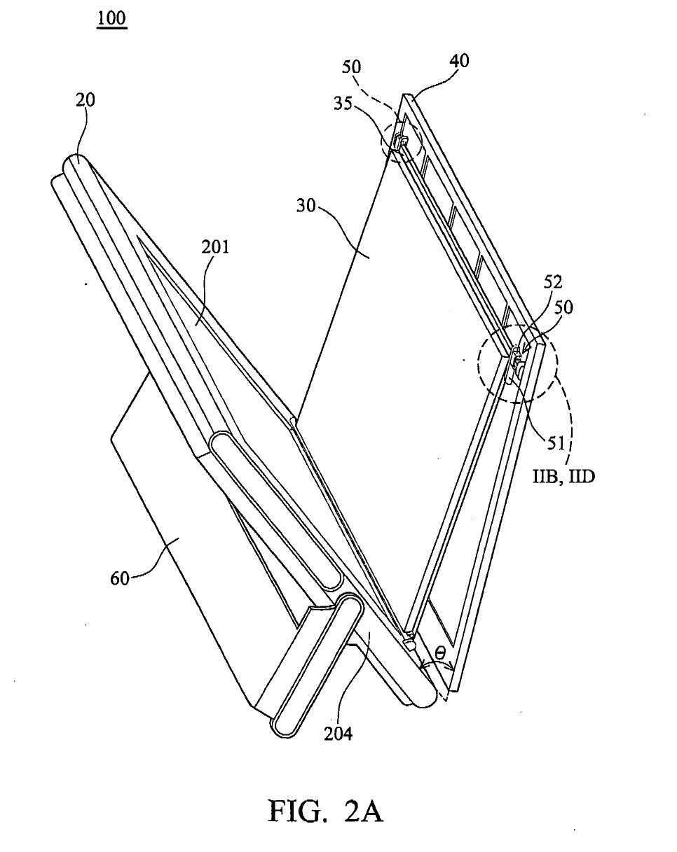

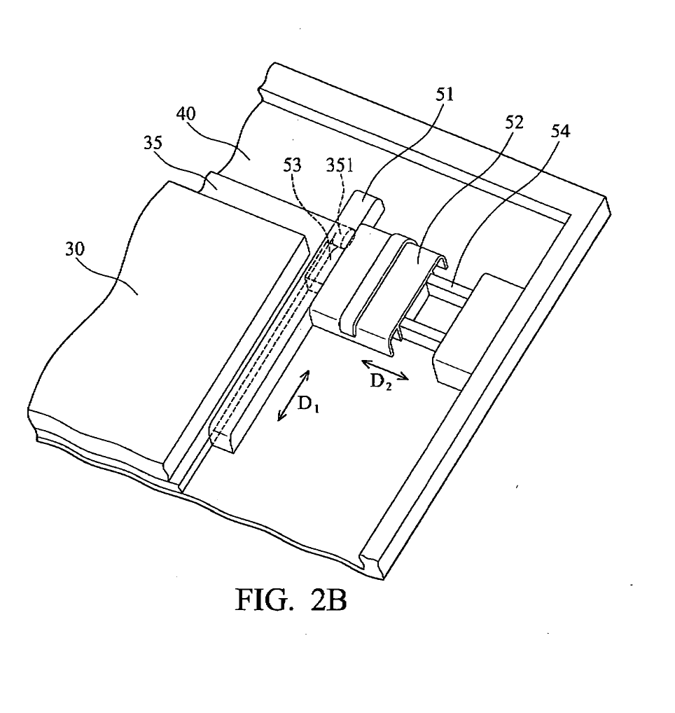

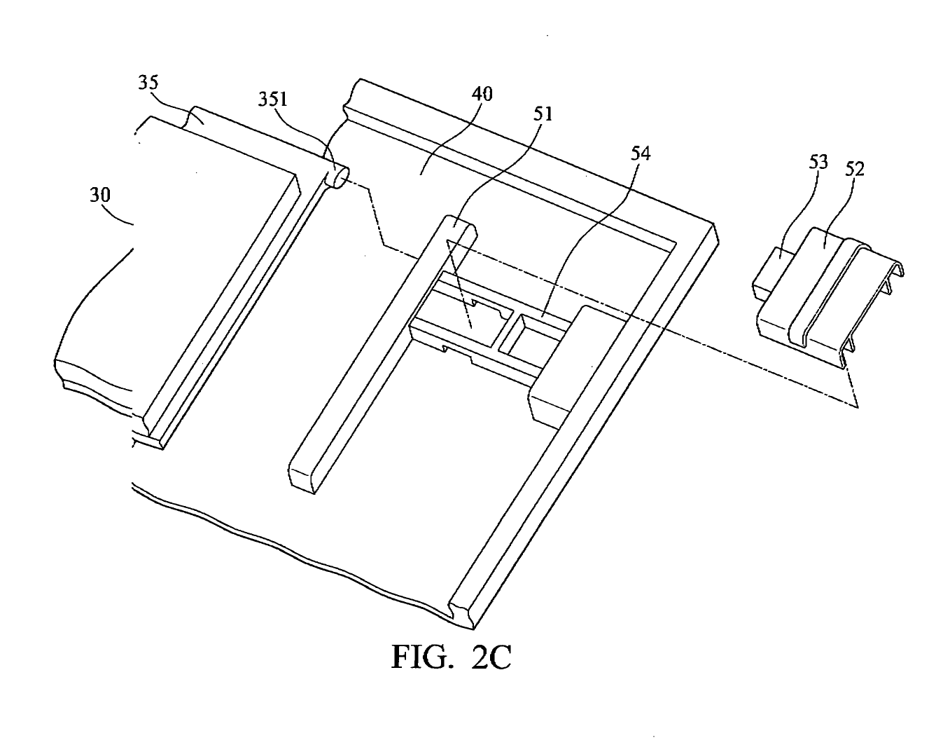

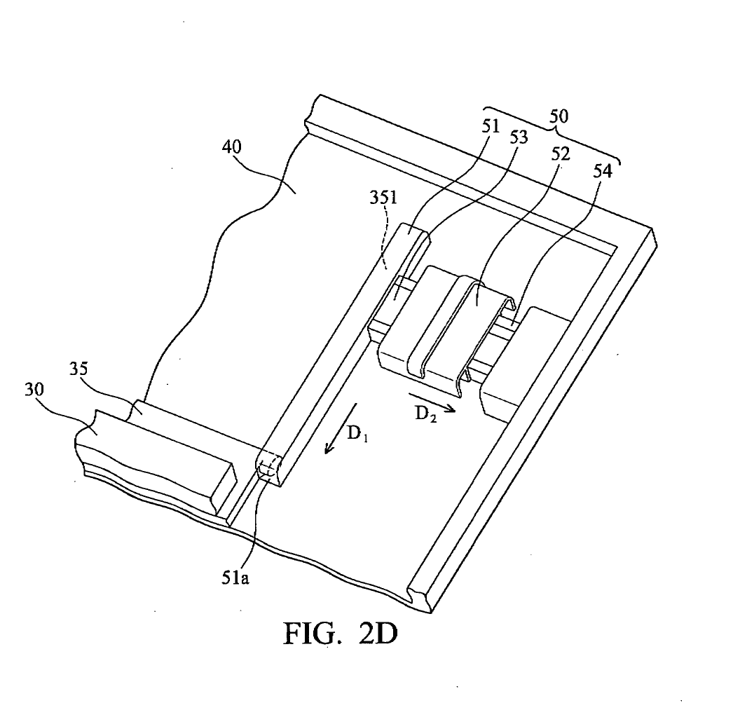

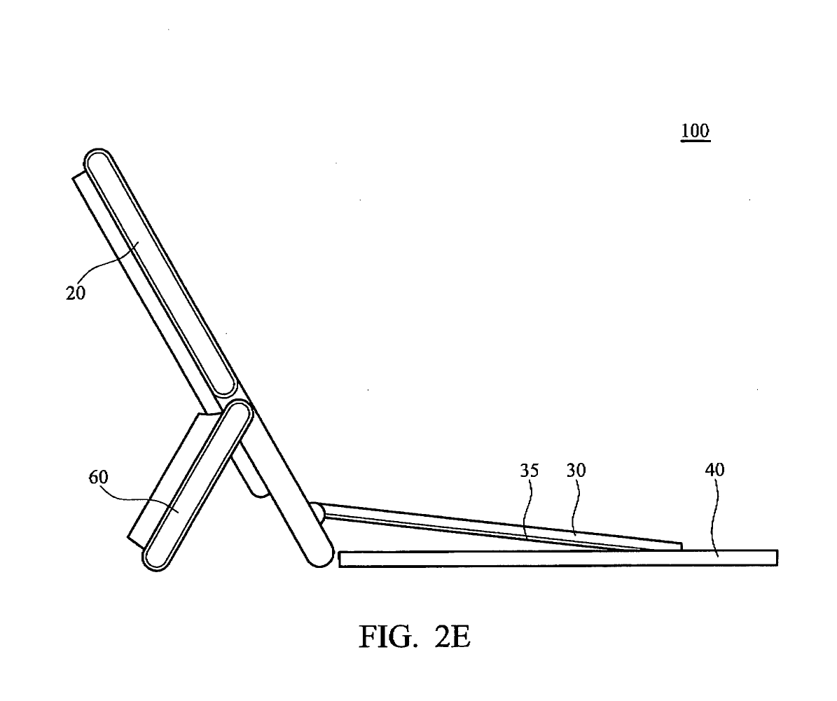

Referring to FIG. 2A, a standing scanner 100 comprises a main body 20, a soft pad 30, a back plate 35, a cover 40, a positioning mechanism 50 and a supporter 60. The soft pad 30 is bonded to the back plate 35. The soft pad 30 can be made of sponge or other soft material. The back plate 35 is pivoted to the main body 20 and slidably disposed on the cover 40. The positioning mechanism 50 disposed on the cover 40 connects the back plate 35 and the cover 40. The back plate 35 is located at a predetermined position with respect to the cover 40, whereby the cover 40 has an angle θ with respect to the main body 20. The angle θ is determined by the positioning mechanism 50. When the scanner is configured for hanging on a wall, the supporter 60 can be omitted. When the cover 40 is opened and a scanned document is placed on the back plate 35, the scanned document leans on the back plate 35. When the cover 40 is closed, the soft pad 30 contacts the document, which is held between the main body 20 and the back plate 35.

Referring to FIGS. 2B and 2C, the back plate 35 comprises a protrusion 351. The positioning mechanism 50 comprises a groove 51 and a sliding block 52. The protrusion 351 can enter the groove 51 and slide in a first direction D1 therein. The sliding block 52 comprises a stop block 53. The stop block 53 can abut and constrain the protrusion 351, whereby the back plate 35 is located at a predetermined position with respect to the cover 40, whereby the cover 40 has an angle θ with respect to the main body 20 as shown in FIG. 2A.

Referring to FIGS. 2D and 2E, the positioning mechanism 50 further comprises a first track 54 disposed on the cover 40. The sliding block 52 slides on the first track 54 in a second direction D2 which is perpendicular to the first direction D1.

In FIG. 2E, when the sliding block 52 slides in the second direction D2, the stop block 53 is separated from the protrusion 351. When not constrained, the protrusion 351 moves in the first direction D1 until it contacts the end 51a of the groove 51, whereby the cover 40 is completely opened.

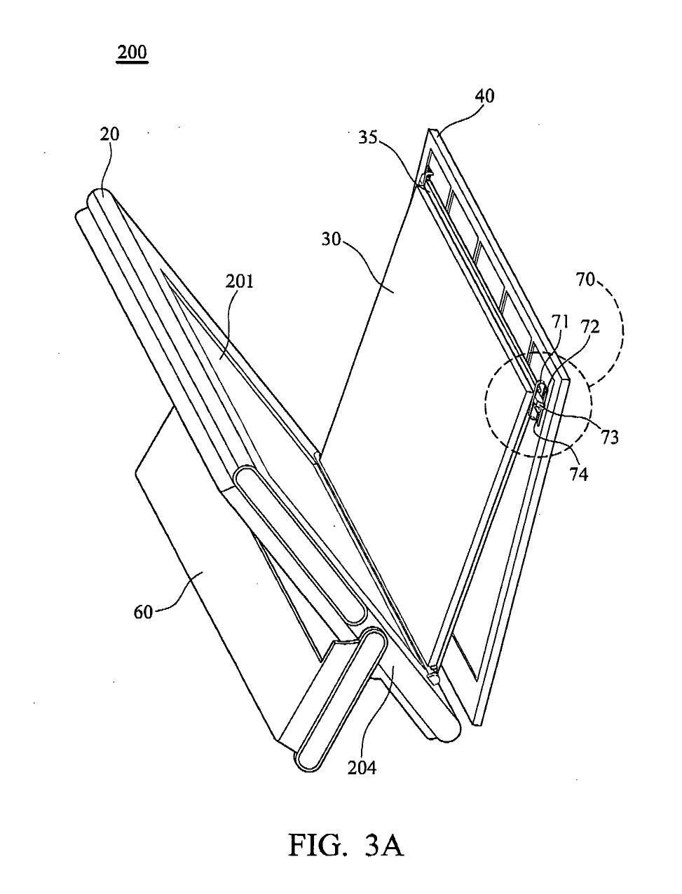

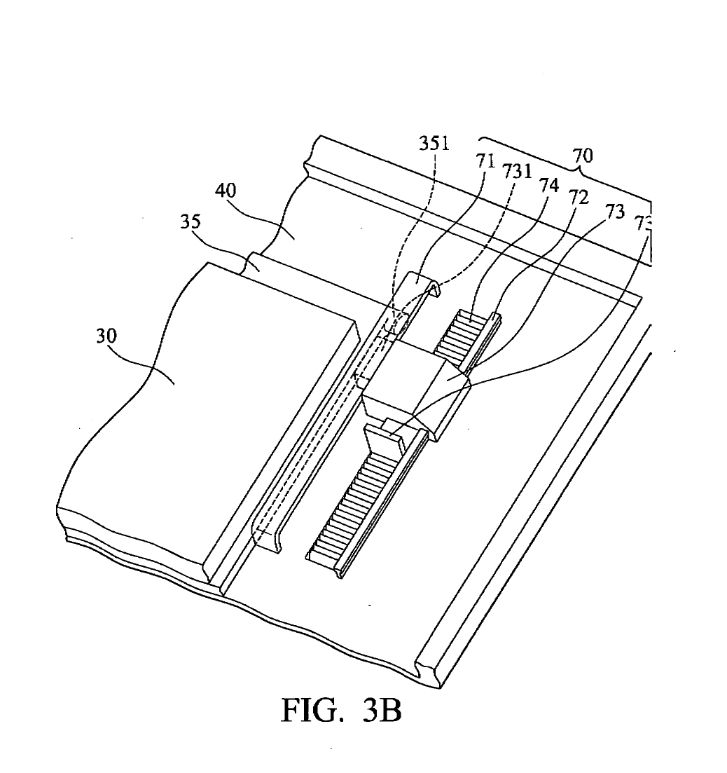

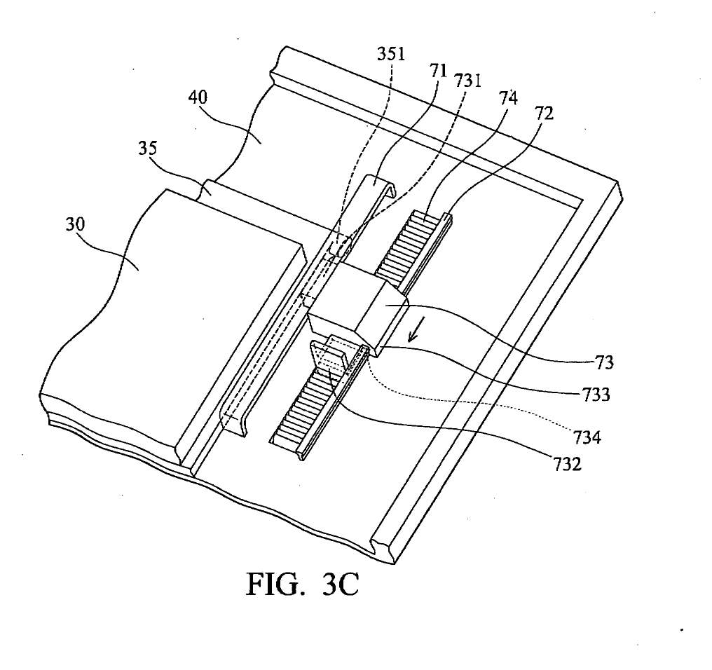

FIGS. 3A, 3B and 3C depict another embodiment of the scanner of the invention. The positioning mechanism 70 comprises a groove 71, a second track 72 and a sliding block 73. The sliding block 73 is slidably disposed on the second track 72 and in the groove 71. Because the second track 72 is parallel to the groove 71, the protrusion 351 moves in the same direction as the sliding block 72 as shown in FIGS. 3B and 3C. The second track 72 comprises a plurality of teeth 74. The sliding block comprises a stop block 731, a hook 732 and a holding portion 733. The stop block 731 abuts the protrusion 351 to determine the moving distance of the protrusion 351. The hook 732 is slidable and holds one of the teeth 74. The holding portion 733 is also slidable and stops on the second track 72. The holding portion 733 comprises a recess 734 corresponding to the second track 74, and the second track 74 extends through the recess 734, whereby the sliding block 72 is slidably disposed on the second track 74. The back plate 35 is slidably connected to the cover 40.

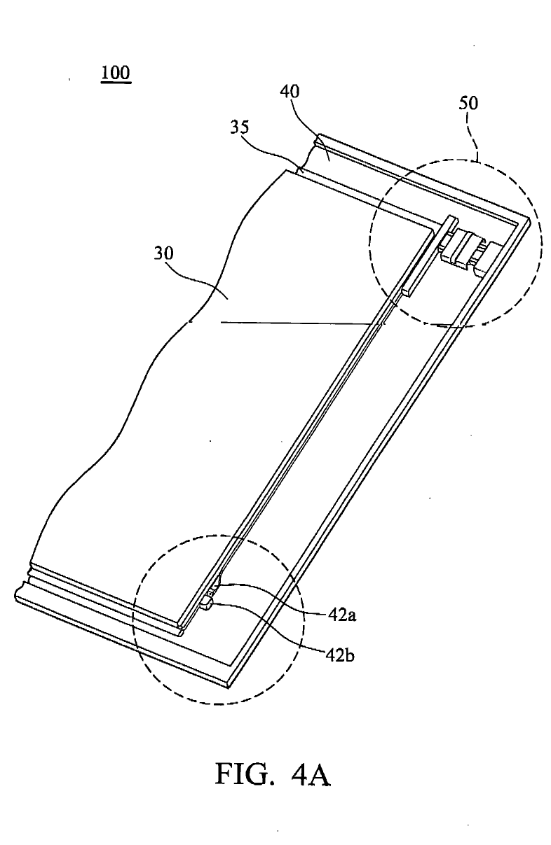

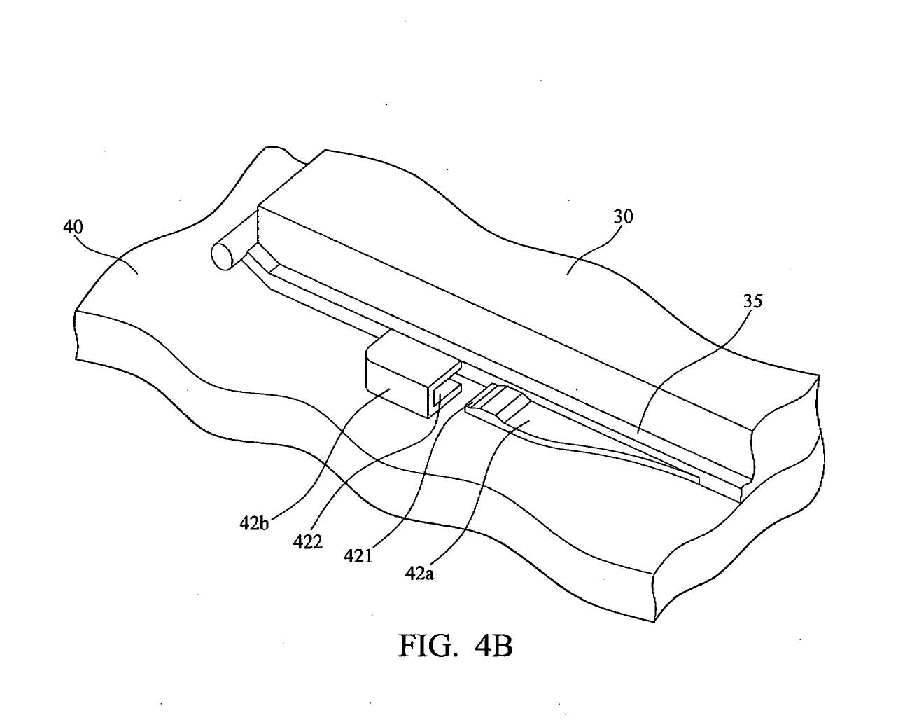

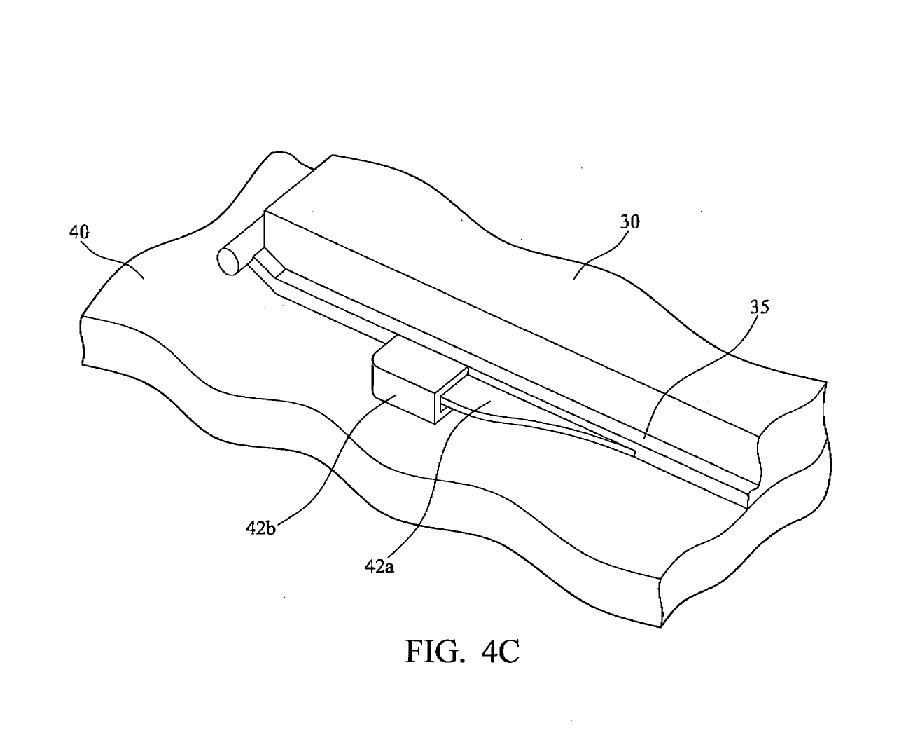

FIGS. 4A, 4B and 4C depict another embodiment of the scanner of the invention. The back plate 35 further comprises an engaging portion 42a having an engaging tip 421. The cover 40 comprises a channel 42b. The channel 42b is U-shaped channel 422. The engaging portion 42a detachably engages the channel 42b. The back plate 35 can be detachably connected to the main body 20. When the scanner is not in use, the engaging portion 42a completely engages the channel 42b, whereby the back plate 35 completely overlaps the cover 40.

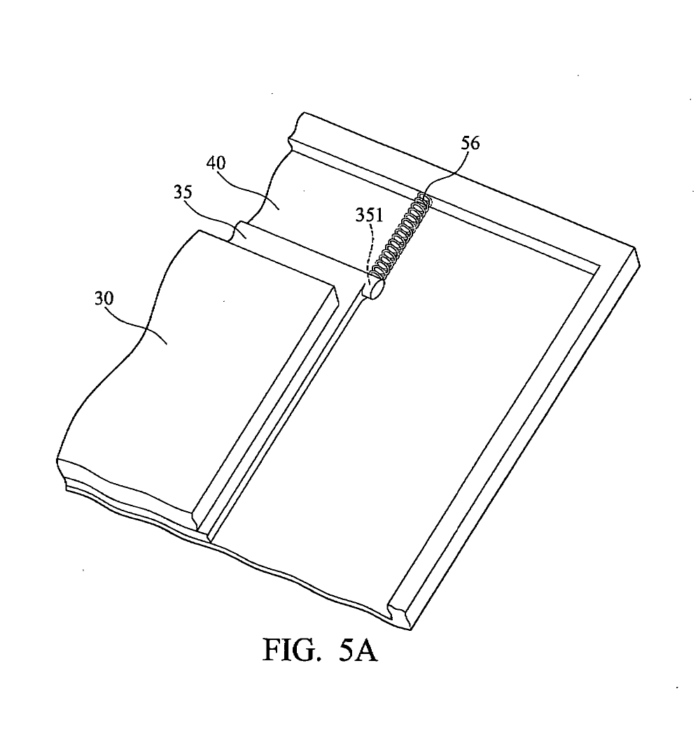

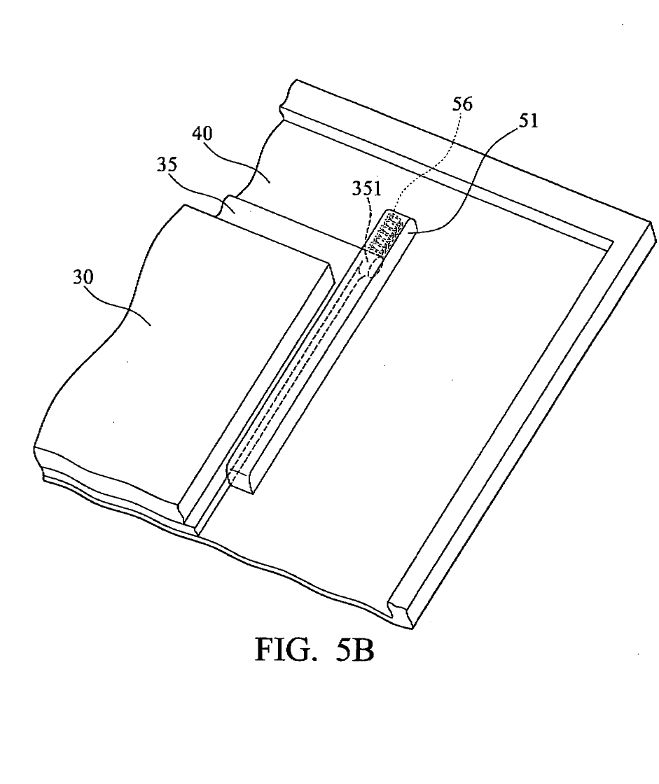

In another embodiment, considering the cost and assembly, a simple mechanism, such as an elastic member, can be used to connect the back plate 35 and the cover 40. In FIG. 5A, the positioning mechanism is a spring 56 connected the protrusion 351 and the cover 40. In FIG. 5B, the spring 56 connects the groove 51 and the protrusion 351. In a simpler structure, the spring 56 of FIG. 5B can be omitted, and the groove 51 is used to constrain the cover 40 to determine the angle θ.

The standing scanner of the invention positions the scanned document and prevents the scanned document from falling off. The scanner of the invention also has a simpler structure and a longer service life of pivot mechanism than the prior art. The scanner of the invention can be easily assembled.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A scanner, comprising;
a main body;
a cover pivoted to the main body;
a back plate disposed between the main body and the cover with one end pivoted to the main body and another end connected to the cover; and
a positioning mechanism disposed on the cover and connecting the back plate and the cover, whereby the back plate is maintained at a predetermined position on the cover at an angle with respect to the main body.

2. The scanner as claimed in claim 1, wherein the back plate comprises a protrusion, and the positioning mechanism comprises a groove where the protrusion slides in the groove in a first direction.

3. The scanner as claimed in claim 2, wherein the positioning mechanism further comprises an elastic element connecting the protrusion and the groove.

4. The scanner as claimed in claim 2, wherein the positioning mechanism further comprises a first track and a sliding block in a second direction slidably disposed on the first track, and the sliding block comprises a stop block constraining the protrusion, whereby the cover is opened at an angle with respect to the main body.

5. The scanner as claimed in claim 4, wherein the first direction is perpendicular to the second direction.

6. The scanner as claimed in claim 1, wherein the back plate comprises a protrusion, and the positioning mechanism comprises a groove and a sliding block slidably disposed in the groove, and the protrusion and the sliding block move in the same direction.

7. The scanner as claimed in claim 6, wherein the sliding block comprises a stop block abutting the protrusion, and the position of the stop block determines the moving distance of the protrusion to determine the angle between the cover and the main body.

8. The scanner as claimed in claim 7, wherein the positioning mechanism further comprises a second track parallel to the groove, and the sliding block is disposed on the second track and slides thereon.

9. The scanner as claimed in claim 8, wherein the second track comprises a plurality of teeth, and the sliding block comprises a hook movably holding one of the teeth.

10. The scanner as claimed in claim 9, wherein the sliding block comprises a holding portion slidably held on the second track.

11. The scanner as claimed in claim 10, wherein the holding portion comprises recess corresponding to the second track.

12. The scanner as claimed in claim 8, wherein the sliding block comprises a holding portion slidably held on the second track.

13. The scanner as claimed in claim 12, wherein the holding portion comprises recess corresponding to the second track.

14. The scanner as claimed in claim 1, wherein the cover comprises a channel, and the back plate comprises an engaging portion detachably engaging the channel; when the engaging portion engages the channel, the back plate is positioned on the cover.

15. The scanner as claimed in claim 14, wherein the engaging portion comprises an engaging tip engaging the channel which is U-shaped.

16. The scanner as claimed in claim 1, wherein the positioning mechanism comprises an elastic element connecting the cover and the back plate.

17. The scanner as claimed in claim 16, wherein the back plate comprises a protrusion, the elastic element connecting the protrusion and the cover.

18. The scanner as claimed in claim 17, wherein the elastic element is a spring.
